(19) United States
(12) Patent Application Publication
(10) Pub. No.: US 2025/0045633 A1
(43) Pub. Date: Feb. 6, 2025

(54) TECHNIQUES FOR TRAINING IDENTITY-ROBUST MACHINE LEARNING MODELS

(71) Applicant: NETFLIX, INC., Los Gatos, CA (US)

(72) Inventors: Shervin Ardeshir BEHROSTAGHI, Campbell, CA (US); Qi QI, Mountain View, CA (US)

(21) Appl. No.: 18/749,378

(22) Filed: Jun. 20, 2024

Related U.S. Application Data
(60) Provisional application No. 63/516,240, filed on Jul. 28, 2023.

(51) Int. Cl. G06N 20/00

(52) U.S. Cl. CPC G06N 20/00

(57) ABSTRACT

In various embodiments, a model trainer application trains a machine learning model with improved identity robustness. The model trainer application first processes images of faces using a trained face recognition model to generate a proxy representation of an identity of the individual in each image. Representations of individuals with similar faces lie in the same neighborhoods within a proxy identity space. The model trainer application trains a machine learning model to perform a task relating to faces while considering the accuracy of each identity proxy neighborhood. The model trainer assigns different weights to each image sample in a neighborhood based on the number of samples with the same output class in that neighborhood. The assigned weights can then be used to compute a relatively unbiased identity loss function that is used to train the machine learning model to perform the task relating to faces while being robust to identity features.

### CROSS-REFERENCE TO RELATED APPLICATIONS

This application claims priority benefit of the United States Provisional Patent Application titled, “TECHNIQUES FOR IMPROVING IDENTITY-ROBUSTNESS FOR FACE MODELS,” filed on Jul. 28, 2023, and having Ser. No. 63/516,240. The subject matter of this related application is hereby incorporated herein by reference.

### BACKGROUND

### Field of the Various Embodiments

The contemplated embodiments relate generally to computer science, artificial intelligence (AI), and machine learning and, more specifically, to techniques for training identity-robust machine learning models.

### Description of the Related Art

Machine learning can be used to discover trends, patterns, relationships, and/or other attributes related to large sets of complex, interconnected, and/or multidimensional data. To glean insights from large data sets, regression models, artificial neural networks, support vector machines, decision trees, naïve Bayes classifiers, and/or other types of machine learning models can be trained using input-output pairs in the data. In turn, the trained machine learning models can be used to guide decisions and/or perform actions related to the data and/or other similar data.

Machine learning models can be trained to perform tasks related to human faces, including regression tasks such as estimating a facial pose or detecting facial landmarks, classification tasks such as facial expression classification, and generative tasks such as avatar creation. For example, facial expression classification identifies human emotions based on facial movements and expressions, such as eye and mouth movements, to infer emotions, such as sadness, happiness, anger, and surprise. To train a machine learning model to perform a face related task, a dataset that includes images of faces can be used to compute losses between outputs of the machine learning model given the images as inputs and ground truth data indicating expected outputs. Losses for all faces in the dataset can be aggregated equally and used to update parameters of the machine learning model. An optimizer minimizes the aggregated loss over a number of training iterations. The trained machine learning model can then be used in various applications, such as to monitor the drivers of vehicles or to monitor consumer reactions.

One drawback of conventional approaches for training a machine learning model to perform a task relating to faces is that the machine learning model can learn to rely on irrelevant and spurious features when performing the task. For example, two machine learning models trained to perform a face-related task can have similar overall performance but different levels of performance across different individuals. The disparity in performance can be due to bias in the training data used to train the two machine learning models. Bias can occur when the number of data points used as different categories of output classes in the training data used to train a machine learning model is not equal or balanced. For example, if person 1 smiles 90% of the time, and person 2 smiles 10% of the time, a machine learning model that is trained to classify persons as smiling or not smiling could associate the facial features of person 1 with the smiling class. Thereafter, the trained machine learning model can always classify images of person 1 as smiling because of the identity of person 1 and not the facial expressions of person 1.

As the forgoing illustrates, what is needed in the art are more effective techniques for training machine learning models.

### SUMMARY

One embodiment of the present disclosure sets forth a computer-implemented method for training a machine learning model. The method includes, for each image included a plurality of images, generating a representation of a face within the image. The method further includes, for each image included the plurality of images, computing a weight based on the representation generated for the image and at least one other representation generated for at least one other image included in the plurality of images. In addition, the method includes performing one or more operations to train the machine learning model based on at least the weights to generate a trained machine learning model.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to the prior art is that, with the disclosed techniques, machine learning models can be trained to perform tasks relating to faces without relying on facial identity features, thereby improving robustness of the machine learning models. In addition, the disclosed techniques do not require balanced data points to train robust machine learning models for different output classes. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a block diagram of a computer-based system configured to implement one or more aspects of the various embodiments;

FIG. 2 is a more detailed illustration of a computing device that is configured to implement one or more aspects of the various embodiments;

FIG. 3 is a more detailed illustration of model trainer of FIG. 1, according to various embodiments;

FIG. 4 is a more detailed illustration of application of FIG. 1, according to various embodiments;

FIG. 5 is a flow diagram of method steps for training a classifier, according to various embodiments; and

FIG. 6 is a flow diagram of method steps for executing application, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

As described, in conventional approaches for training a machine learning model to perform a task relating to faces, a dataset that includes images of faces can be used to compute losses between outputs of the machine learning model given the images as inputs and ground truth data indicating expected outputs. Losses for all faces in the dataset can then be aggregated equally and used to update parameters of the machine learning model, and an optimizer can minimize the aggregated loss over a number of training iterations. However, during such training, the machine learning model can learn to rely on irrelevant and spurious features when performing the task. For example, if person 1 smiles 90% of the time, and person 2 smiles 10% of the time, a machine learning model that is trained to classify persons as smiling or not smiling could associate the facial features of person 1 with the smiling class. Thereafter, the trained machine learning model can always classify images of person 1 as smiling because of the identity of person 1 and not the facial expressions of person 1.

The disclosed techniques improve the identity-robustness of machine learning models. In some embodiments, a model trainer application first processes images of faces using a trained face recognition model to generate a proxy representation of an identity of the individual in each image. Representations of individuals with similar facial features lie in the same neighborhoods within a proxy identity space. A neighborhood can be defined with a hard threshold or a soft threshold. A hard threshold sets a radius of the neighborhood. A soft threshold is defined based on a distance metric, such as cosine distance. Instead of excluding representations of individuals outside a predefined distance, in some embodiments, a soft threshold can emphasize representations of individuals with closer distances and de-emphasize representations of individuals with further distances. The model trainer application trains a machine learning model to perform a task relating to faces while considering the accuracy of each identity proxy neighborhood. Instead of training the machine learning model to perform well on average, the model trainer assigns different weights to each image sample in a neighborhood based on the number of samples with the same output class in that neighborhood. The assigned weights can then be used to compute an unbiased identity loss function that is used to train the machine learning model to perform the task relating to faces while being robust to identity features.

Advantageously, the disclosed techniques address various limitations of conventional approaches for training machine learning models. More specifically, with the disclosed techniques, machine learning models can be trained to perform tasks relating to faces without relying on facial identity features, thereby improving robustness of the machine learning models. In addition, the disclosed techniques do not require balanced data points to train robust machine learning models for different output classes. These technical advantages represent one or more technological improvements over prior art approaches.

### System Overview

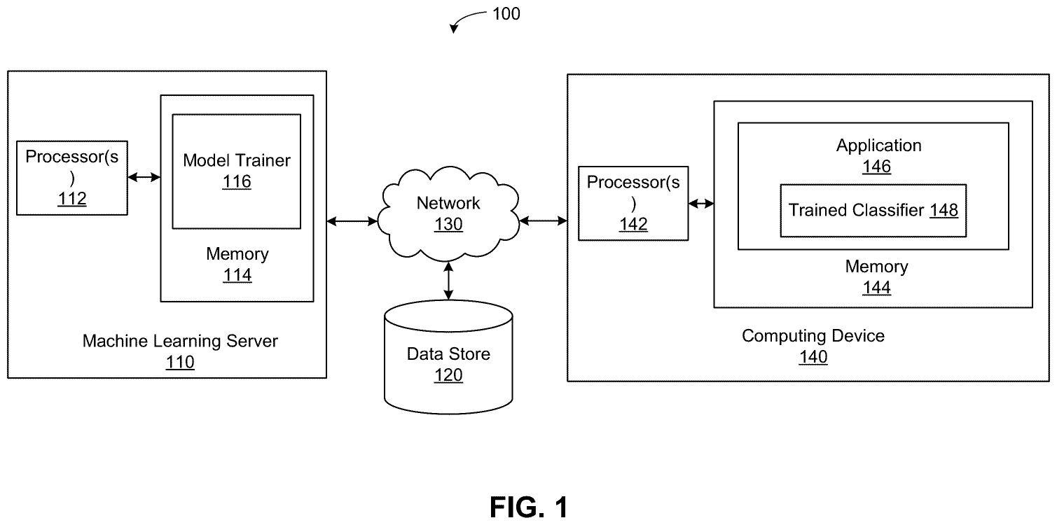

FIG. 1 illustrates a block diagram of a computer-based system 100 configured to implement one or more aspects of the various embodiments. As shown, the system 100 includes a machine learning server 110, a data store 120, and a computing device 140 in communication over a network 130, which can be a wide area network (WAN) such as the Internet, a local area network (LAN), a cellular network, and/or any other suitable network.

The machine learning server 110 includes, without limitation, processor(s) 112 and a memory 114. The processor(s) 112 receive user input from input devices, such as a keyboard or a mouse. In operation, the one or more processors 112 may include one or more primary processors that control and coordinate the operations of the other system components within the machine learning server 110. In particular, the processor(s) 112 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

The system memory 114 of the machine learning server 110 stores content, such as software applications and data, for use by the processor(s) 112 and the GPU(s) and/or other processing units. The system memory 114 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace the system memory 114. The storage can include any number and type of external memories that are accessible to processor 112 and/or the GPU. For example, and without limitation, the storage can include a Secure Digital Card, an external Flash memory, a portable compact disc read-only memory (CD-ROM), an optical storage device, a magnetic storage device, and/or any suitable combination of the foregoing.

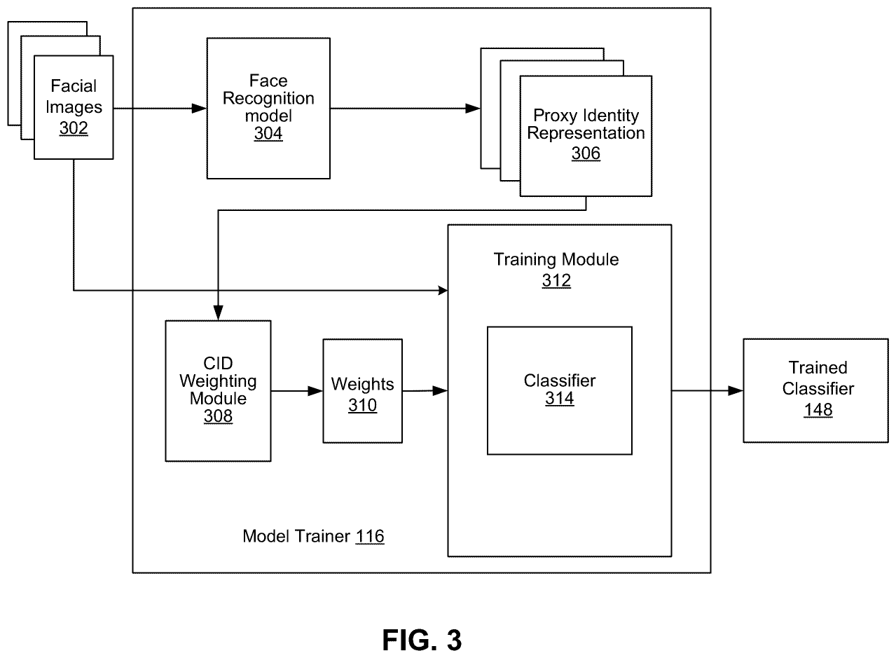

As also shown, memory 114 includes a model trainer 116. Model trainer 116 is configured to train a classifier 148 that can then be deployed to any suitable application, such as application 146 that executes on a computing device 140. The operations performed by model trainer 116 when training classifier 148 are described in greater detail below in conjunction with FIG. 3. In some embodiments, model trainer 116 can dynamically adjust training parameters and methodologies by incorporating a feedback loop that leverages real-time analysis of any performance metric, such as precision, recall, and loss functions. Model trainer 116 can also make adjustments to optimize outputs and learned outcomes. These adjustments can include, without limitation, modifications to learning rates, model architectures, and data processing techniques. In some embodiments, model trainer 116 uses one or more data preprocessors that address common issues such as imbalanced datasets, missing values, and noise, thereby ensuring that the data fed into the model is clean, relevant, and representative of the problem space. In various embodiments, model trainer 116 uses data augmentation techniques, which artificially expand the training dataset to improve the generalization capabilities of the model, and tailored adjustments to the data.

The machine learning server 110 shown herein is for illustrative purposes only, and variations and modifications are possible without departing from the scope of the present disclosure. For example, the number of processors 112, the number of GPUs and/or other processing unit types, the number of system memories 114, and/or the number of applications included in the system memory 114 can be modified as desired. Further, the connection topology between the various units in FIG. 1 can be modified as desired. In some embodiments, any combination of the processor(s) 112, the system memory 114, and/or GPU(s) can be included in and/or replaced with any type of virtual computing system, distributed computing system, and/or cloud computing environment, such as a public, private, or a hybrid cloud system.

The computing device 140 includes, without limitation, processor(s) 142 and a memory 144. Processor(s) 142 receive user input from input devices, such as a keyboard or a mouse. Similar to processor(s) 112 of machine learning server 110, in some embodiments, processor(s) 142 may include one or more primary processors that control and coordinate the operations of the other system components within the computing device 140. In particular, the processor(s) 142 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

Similar to system memory 114 of machine learning server 110, system memory 144 of computing device 140 stores content, such as software applications and data, for use by the processor(s) 142 and the GPU(s) and/or other processing units. The system memory 144 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace the system memory 144. The storage can include any number and type of external memories that are accessible to processor 142 and/or the GPU. For example, and without limitation, the storage can include a Secure Digital Card, an external Flash memory, a portable compact disc read-only memory (CD-ROM), an optical storage device, a magnetic storage device, and/or any suitable combination of the foregoing.

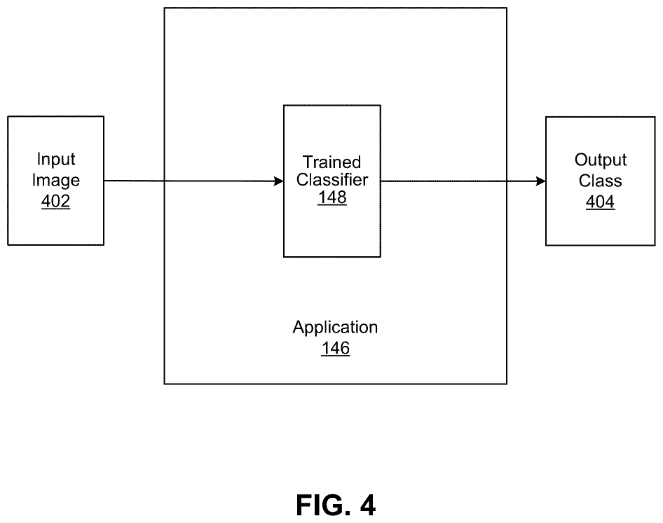

As also shown, system memory 144 includes application 146 that uses trained classifier 148 to generate classifications for a face related task. In some embodiments, an input image can be provided to application 146 via a user interface or in any other suitable manner. In such cases, application 146 can apply the trained classifier 148 on the input image to generate a classification, which can be directly output by application 146 or used in any technically feasible manner by application 146. Trained classifier 148 can be any type of technically-feasible machine learning model. For example, in various embodiments, trained classifier 148 can be Convolutional Neural network, a Vision Transformer, a diffusion model, a support vector machine (SVM), etc. The operations that can be performed by application 146 are described in greater detail below in conjunction with FIG. 4.

Data store 120 provides non-volatile storage for applications and data in machine learning server 110 and computing device 140. For example, and without limitation, training data, trained (or deployed) machine learning models and/or application data, including the CAD data generator 148, may be stored in the data store 120. In some embodiments, data store 120 may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Data store 120 can be a network attached storage (NAS) and/or a storage area-network (SAN). Although shown as accessible over network 130, in various embodiments, the machine learning server 110 or computing device 140 can include the data store 120.

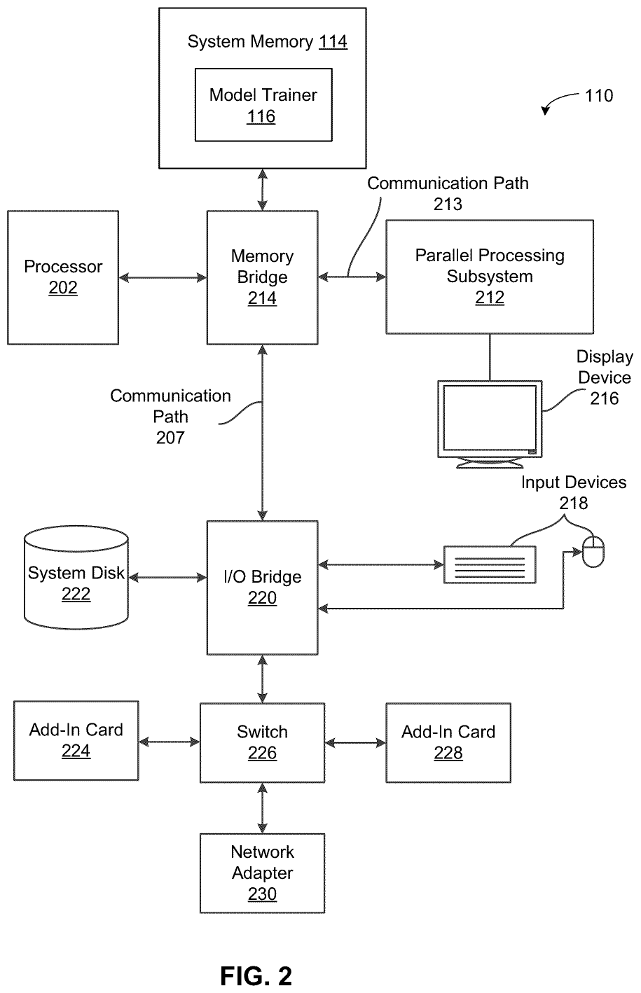

FIG. 2 is a block diagram illustrating a computing device 200 configured to implement one or more aspects of the various embodiments. Computing device 200 may be any type of computing device, including, without limitation, a server machine, a server platform, a desktop machine, a laptop machine, a hand-held/mobile device, a digital kiosk, an in-vehicle infotainment system, and/or a wearable device. In some embodiments, computing device 200 is a server machine operating in a data center or a cloud computing environment that provides scalable computing resources as a service over a network.

As shown, the computing device 200 includes, without limitation, the processor(s) 202 and a system memory(ies) 114 coupled to a parallel processing subsystem 212 via a memory bridge 214 and a communication path 213. Memory bridge 214 is further coupled to an I/O (input/output) bridge 220 via a communication path 207, and I/O bridge 220 is, in turn, coupled to a switch 226.

In various embodiments, I/O bridge 220 is configured to receive user input information from optional input devices 218, such as a keyboard, mouse, touch screen, sensor data analysis (e.g., evaluating gestures, speech, or other information about one or more uses in a field of view or sensory field of one or more sensors), and/or the like, and forward the input information to the processor(s) 202 for processing. In some embodiments, the computing device 200 may be a server machine in a cloud computing environment. In such embodiments, computing device 200 may not include input devices 218, but may receive equivalent input information by receiving commands (e.g., responsive to one or more inputs from a remote computing device) in the form of messages transmitted over a network and received via the network adapter 230. In some embodiments, switch 226 is configured to provide connections between I/O bridge 220 and other components of the computing device 200, such as a network adapter 230 and various add-in cards 224 and 228.

In some embodiments, I/O bridge 220 is coupled to a system disk 222 that may be configured to store content and applications and data for use by processor(s) 202 and parallel processing subsystem 212. In one embodiment, system disk 222 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 220 as well.

In various embodiments, memory bridge 214 may be a Northbridge chip, and I/O bridge 220 may be a Southbridge chip. In addition, communication paths 207 and 213, as well as other communication paths within computing device 200, may be implemented using any technically suitable protocols, including, without limitation, AGP (Accelerated Graphics Port), HyperTransport, or any other bus or point-to-point communication protocol known in the art.

In some embodiments, parallel processing subsystem 212 comprises a graphics subsystem that delivers pixels to an optional display device 216 that may be any conventional cathode ray tube, liquid crystal display, light-emitting diode display, and/or the like. In such embodiments, the parallel processing subsystem 212 may incorporate circuitry optimized for graphics and video processing, including, for example, video output circuitry. Such circuitry may be incorporated across one or more parallel processing units (PPUs), also referred to herein as parallel processors, included within the parallel processing subsystem 212.

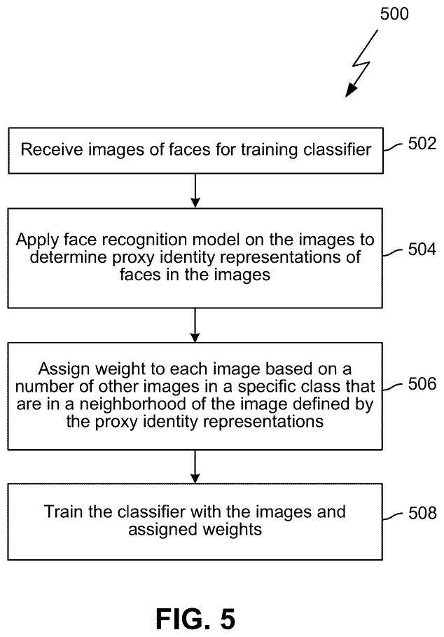

In some embodiments, the parallel processing subsystem 212 incorporates circuitry optimized (e.g., that undergoes optimization) for general purpose and/or compute processing. Again, such circuitry may be incorporated across one or more PPUs included within parallel processing subsystem 212 that are configured to perform such general purpose and/or compute operations. In yet other embodiments, the one or more PPUs included within parallel processing subsystem 212 may be configured to perform graphics processing, general purpose processing, and/or compute processing operations. System memory 114 includes at least one device driver configured to manage the processing operations of the one or more PPUs within parallel processing subsystem 212. In addition, system memory 114 includes model trainer 116 which trains a relatively robust machine learning model by assigning different weights to each sample in the training data based on the number of samples with similar output class in a specific neighborhood, as discussed in greater detail below in conjunction with FIGS. 3 and 5. Model trainer 116 defines neighborhoods using similarity of each sample to the other samples.

In various embodiments, parallel processing subsystem 212 may be integrated with one or more of the other elements of FIG. 2 to form a single system. For example, parallel processing subsystem 212 may be integrated with processor 202 and other connection circuitry on a single chip to form a system on a chip (SoC).

In some embodiments, communication path 213 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of CPUs 202, and the number of parallel processing subsystems 212, may be modified as desired. For example, in some embodiments, system memory 114 could be connected to the processor(s) 202 directly rather than through memory bridge 214, and other devices may communicate with system memory 114 via memory bridge 214 and processor 202. In other embodiments, parallel processing subsystem 212 may be connected to I/O bridge 220 or directly to processor 202, rather than to memory bridge 214. In still other embodiments, I/O bridge 220 and memory bridge 214 may be integrated into a single chip instead of existing as one or more discrete devices. In certain embodiments, one or more components shown in FIG. 2 may not be present. For example, switch 226 could be eliminated, and network adapter 230 and add-in cards 224, 228 would connect directly to I/O bridge 220. Lastly, in certain embodiments, one or more components shown in FIG. 2 may be implemented as virtualized resources in a virtual computing environment, such as a cloud computing environment. In particular, the parallel processing subsystem 212 may be implemented as a virtualized parallel processing subsystem in at least one embodiment. For example, the parallel processing subsystem 212 may be implemented as a virtual graphics processing unit(s) (vGPU(s)) that renders graphics on a virtual machine(s) (VM(s)) executing on a server machine(s) whose GPU(s) and other physical resources are shared across one or more VMs.

### Training Identity-Robust Machine Learning Models

FIG. 3 is a more detailed illustration of model trainer 116 of FIG. 1, according to various embodiments. As shown, model trainer 116 includes a face recognition model 304, a conditional inverse density (CID) weighting module 308, and a training module 312 that includes a classifier 314. Classifier 314 is a machine learning model that model trainer 116 can train to generate trained classifier 148 that is able to perform one or more classification tasks relating to faces, such as recognizing different classes of facial emotions in input images, classifying if mouths are open or closed in input images, or the like. Any technically feasible type of machine learning model, such as an artificial neural network or a SVM, can be used as classifier 314 in some embodiments.

In operation, model trainer 116 receives images that include faces 302 (also referred to herein as facial images 302). Given such inputs, model trainer 116 trains a classifier 314 using facial images 302 as training data and a conditional inverse density weighting for each of a number of classes, normalized for all classes, to generate a trained classifier 148 that performs relatively robustly across facial images of different people for a classification task, such as facial expression classification, mouth slightly open classification, or face shape classification.

More formally, facial images 302 can be a dataset D={X×Y}={(xᵢ, yᵢ)}ᵢ₌₁^{|D|} with size n=|D|, and a total number of output classes C, e.g., |Y|=C·D_{y}={(xᵢ, yᵢ)|yᵢ=y, i∈[1, . . . , |D|]} represents sample images (also referred to herein as “samples”) in facial images 302 whose task label is y∈Y. gᵢ∈G denotes the identity and group that sample i belongs to, across which performance disparity should be mitigated.

Face recognition model 304 is a machine learning model trained to recognize faces in images, and model trainer applies face recognition model 304 to extract representations of the identities of faces in facial images 302. Illustratively, model trainer 116 uses face recognition model 304 to convert facial images 302 into proxy identity representations 306, which can, in some embodiments, be vectors of features that act as noisy proxies of the identities of faces in facial image 302. Since group and identity labels G of facial images 302 may not be available during training of classifier 314, the proxy identity representations {zᵢ}ᵢ₌₁^{|D|} extracted from face recognition model 304 are provided as proxies for determining group and identity of faces within facial images 302. Face recognition model 304 can be any technically feasible facial recognition model, such as DeepFace or OpenFace.

CID weighting module 308 receives proxy identity representations 306 and generates weights 310 that are applied by training module 312 during training of classifier 314. In some embodiments, CID weighting module 308 uses a sample-weighting scheme based on the CID of each sample in a proxy identity space to generate weights 310. Doing so permits identity-related content and non-identity related content within facial images 302 to be disentangled, without requiring explicit information about the identities of faces in facial images 302. In some embodiments, CID weighting module 308 can generate, for each facial image 302, a weight that is computed as an exponential of similarity of that facial image 302 to other facial images 302, normalized based on the number of classes to be predicted by trained classifier 148. The similarities can be computed using any technically feasible metric, such as cosine distance. Such a weighting is also referred to herein as a conditional inverse density weighting for each class, normalized for all classes.

More specifically, in some embodiments, CID weighting module 308 can create a batch-wise scheme such that samples in each batch are conditioned on a task label. In such cases, CID weighting module 308 generates a constraint set D_{y} with samples having the same task label in each batch B, e.g., B_{yi} (thus, conditioned on task label). CID weighting module 308 then computes sample weight pᵢ^{τ} according to equation (1). In equation (1), the weight for a sample is computed as an exponential of similarity of the same to other samples, normalized based on the number of classes.

$${p}_{i}^{τ} = \frac{exp ( \frac{{z}_{i}^{⊤} {z}_{i}}{τ} )}{{Σ}_{k = 1}^{\vert {s}_{i v} \vert} exp ( \frac{{z}_{Z}^{⊤} {z}_{k}}{τ} )} , \qquad ( 1 )$$

where the numerator is the exponential of the inner product of the proxy identity representations zᵢ of sample (xᵢ, yᵢ), and the denominator aggregates the exponential pairwise similarities of proxy identity representations between sample (xᵢ, yᵢ) and B_{y}_{ᵢ} in a proxy identity neighborhood. The regularizer hyperparameter τ measures the proximity and magnitude of the neighborhood.

In equation (1), pᵢ^{τ}∈(0,1] represents the importance of the sample (xᵢ, yᵢ) in a local neighborhood within the proxy identity space and τ controls the skewness of the exponential function, which influences the size of the local neighborhood. Even though the constraint set is defined in B_{yi}, the regularizer hyperparameter τ in the exponential function encourages the denominator to focus on the local neighbors of (xᵢ, yᵢ) that share the same facial features. In some embodiments, the size of the local neighborhood can be determined by a predefined threshold. In some other embodiments, there can be different neighborhood sizes that better approximate different identities and group memberships.

The fewer the samples in the local neighborhood, the higher the pᵢ^{τ}. Hence, pᵢ^{τ} is inversely proportional to the class-conditional sample density in the local neighborhood and emphasizes rare samples within each output class. For example, if a sample lies in a denser neighborhood, e.g., has more close neighbors, the pᵢ^{τ} of the sample will be smaller than the pᵢ^{τ} of a sample with less close neighbors. In some embodiments, all samples within the same output class are weighted uniformly and based on the inverse of the sample frequency.

Training module 312 receives weights 310 and facial images 302 that are used to train classifier 314. Given such inputs, training module 312 trains classifier 314 to generate trained classifier 148. Trained classifier 148 is a trained machine learning model, such as an artificial neural network or a SVM, that is trained to perform a classification task, such as recognizing different classes of facial emotions in input facial images, classifying if mouths are open or closed in input images, or the like. Any technically feasible type of machine learning model can be trained as trained classifier 148 in some embodiments, and training module 312 can use any suitable training technique to train classifier 314, such as backpropagation with gradient descent or a variation thereof. During the training, model trainer 116 can use a loss function in which the loss computed for each facial image 302 in the training data set is weighted according to the weight generated for that facial image 302 by CID weighting module 308. In such cases, after facial images 302 are input into classifier 314 to generate outputs, model trainer 116 can compute a loss for each facial image 302 based on a comparison between (1) the output for that facial image 302, and (2) a ground truth classification. Then, model trainer 116 can apply the weight computed by CID weighting module 308 for each facial image 302 to the loss computed for that facial image 302 to compute a weighted average of the losses, and model trainer 116 can update parameters of classifier 314 based on the weighted average of losses. The foregoing process can be repeated for a number of iterations, until a stopping condition (e.g., after a predefined number of iterations have been performed or the weighted average of losses does not improve by more than a threshold amount) is satisfied, to generate trained classifier 148. It should be noted that, rather than computing a per-image accuracy of outputs of classifier 314, such a loss function permits model trainer 116 to compute the accuracy of outputs of classifier 314 in different regions of the proxy identity space and evaluate the accuracy across neighborhoods of the proxy identity space, thereby providing identity-robustness to trained classifier 314. In some other embodiments, neighborhoods can be defined with a hard threshold that sets a predefined radius of each neighborhood, as opposed to the soft threshold neighborhoods of equation (1). Hard thresholds can exclude representations of individuals outside a predefined distance, whereas soft thresholds can emphasize representations of individuals with closer distances and de-emphasize representations of individuals with further distances.

More specifically, in some embodiments, during training and after sample weights pᵢ^{τ} 310 have been computed, training module 312 minimizes the objective function in equation (2) such that pᵢ^{τ} is normalized using Zₚᵢ to equalize the total contribution of each output class. The objective function can be defined as a min-max form, which improves the performance of classifier 314 on the least accurate areas of the proxy identity space.

$${min}_{w} {Σ}_{i = 1}^{n} \frac{{p}_{i}^{τ}}{{z}_{{y}_{i}}} ℓ ( w ; {x}_{i} , {y}_{i} ) \qquad ( 2 )$$

$$s . t arg {max}_{{p}_{i} ∈ {Δ𝒟}_{{y}_{i}}} {Σ}_{j ∈ {𝒟}_{{y}_{i}}} {p}_{i j} {z}_{i}^{⊤} {z}_{j} - τ K L ( {p}_{i} , \frac{1}{\vert {𝒟}_{{y}_{i}} \vert} ) ,$$

where pᵢ^{τ} denotes the sample weight, l(w; xᵢ, yᵢ) denotes the prediction loss, and Z_{y}_{ᵢ}=

$${Σ}_{i ∈ {D}_{{y}_{i}}}$$

pᵢ^{τ} is the class-level normalization parameter to guarantee each output class contributes equally. The pᵢ^{τ} computed according to equation (1) is the maximum value for the constraint in equation (2) that is imposed on the pairwise similarity of proxy identity representations, leveraging the proxy neighborhood structure associated with each sample. More specifically, for ∀(xᵢ, yᵢ)˜D, pᵢ=(pᵢ₁, . . . , pᵢᵢ, . . . ,

$${p}_{i \vert {D}_{{y}_{i}}}$$

refers to the weight assigned to each sample based on

$${\{ {z}_{i}^{⊤} {z}_{j} \}}_{j ∈ {D}_{{y}_{i}}}$$

and satisfies

$${Δ}_{{D}_{{y}_{i}}}$$

={Σⱼpᵢⱼ=1, pᵢⱼ≥0}. The Kullback-Leibler (KL) divergence regularizer Σⱼpᵢⱼ log(|D_{y}_{ᵢ}|pᵢⱼ) between the uniform distribution 1/|D_{y}_{ᵢ}| and the pairwise weights pᵢ encourages the model to focus on the local neighborhood.

In some embodiments, training module 312 uses the performance of classifier 314 across different local neighborhoods in the proxy identity space to estimate disparity across identities and groups. In such cases, training module 312 can fine-tune the regularizer hyper-parameter τ for exploring different neighborhood sizes and therefore exploring different density estimations of disparity across identities and groups during training of classifier 314.

Algorithm 1 describes steps that model trainer 116 can perform to train classifier 314.

Algorithm 1 CID Optimization (τ)

1: Model initialization w₁, proxy embeddings {zᵢ}_{i =} ₁ⁿ
2: for t = 1, . . . , T do
3: Sample a batch of B samples [symbol] = {(xᵢ, yᵢ)}ᵢ^{B} ~ [symbol]
4: Retrieve the proxy embedding vectors of batch samples, {zᵢ}_{i =} ₁^{B}.
5: Calculate pᵢ^{t} according to Eqn (1) for ∀(xᵢ, yᵢ) ∈ [symbol]
6: Calculate ${Z}_{{y}_{i}} = {\sum }_{j ∈ {B}_{{y}_{i}}} {p}_{j}^{τ}$
7: Calculate CID loss: ${\sum }_{i ∈ B} \frac{{p}_{l}^{τ} {ℓ}_{i} ( {w}_{t} )}{( {Z}_{{y}_{i}} )}$
8: Update w_{ι} using stochastic algorithms.
9: end for
10: Return w_{T + 1},

FIG. 4 is a more detailed illustration of application 146 of FIG. 1, according to various embodiments. As shown, application 146 includes trained classifier 148. In operation, application 146 receives an input image 402 that includes a face and executes trained classifier 148 on input image 402 to generate an output class 404. As described, trained classifier 148 is a trained machine learning model, such as an artificial neural network or a SVM, that is trained to perform a classification task, such as recognizing different classes of facial emotions in input facial images, classifying if mouths are open or closed in input facial images, or the like. Any technically feasible type of machine learning model can be trained according to techniques disclosed herein to generate trained classifier 148.

Output class 404 is a specific category or label that trained classifier 148 predicts for a given input image 402. Output class 404 can be an output to any classification task, such as a multi-label classification task with different classes of facial emotions (e.g., happy, sad, angry, and disgusted). In some embodiments, output class 404 can be an output to a binary classification task, such as classifying if a mouth is slightly open, or the mouth is closed. Although application 146 is shown as outputting output class 404, in some embodiments, an application can use outputs of a classifier that is trained according to techniques disclosed herein in any technically feasible manner, such as to generate other outputs.

FIG. 5 is a flow diagram of method steps for training a classifier, according to various embodiments. Although the method steps are described in conjunction with the systems of FIGS. 1-4, persons skilled in the art will understand that any system configured to perform the method steps in any order falls within the scope of the various embodiments.

As shown, a method 500 begins at step 502, where model trainer 116 receives facial images 302 for training classifier 314. In some embodiments, model trainer 116 receives facial images 302 from a storage system (e.g., data store 120).

At step 504, model trainer 116 executes trained face recognition model 304 on the facial images 302 to determine proxy identity representations 306 of faces in the facial images 302. Since group and identity labels G of facial images 302 may not be available for training, the proxy identity representations 306 extracted by the face recognition model 304 are provided as proxies for determining group and identity of faces within facial images 302. In some embodiments, face recognition model 304 can be any technically feasible facial recognition model, such as DeepFace or OpenFace.

At step 506, model trainer 116 assigns a weight to each facial image 302 based on a number of other images in a specific class that are in a neighborhood of the image defined by the proxy identity representations 306. In some embodiments, CID weighting module 308 uses a sample-weighting scheme based on the CID of each sample in the proxy identity space. As described, in some embodiments, CID weighting module 308 can assign to each facial image 302, a weight that is computed as an exponential of similarity of that facial image 302 to other facial images 302, normalized based on the number of classes. In such cases, the similarities can be computed using any technically feasible metric, such as cosine distance. More specifically, in some embodiments, CID weighting module 308 can compute a sample weight pᵢ^{τ} for each facial image 302 according to equation (1) that represents the importance of the sample image (xᵢ, yᵢ) in a local neighborhood of the proxy identity space and τ controls the skewness of the exponential function that influences the size of the local neighborhood. In some embodiments, the size of the local neighborhood can be determined by a predefined threshold. In some other embodiments, there can be different neighborhood sizes that better approximate different identities and group memberships, with the sample weight being inversely proportional to the class-conditional sample density in the local neighborhood so as to emphasize rare samples within each output class, as described above in conjunction with FIG. 3.

At step 508, model trainer 116 trains classifier 314 with the facial images 302 and assigned weights 310. Model trainer 116 trains classifier 314 to generate trained classifier 148 that can perform relatively robustly across facial images 302 of different people for a classification task, such as facial expression classification, mouth slightly open classification, or face shape classification. Training module 312 can use any suitable training technique to train classifier 314, such as backpropagation with gradient descent or a variation thereof. During such training, model trainer 116 can use a loss function that includes a weighted average of losses computed for facial images 302 in which the loss computed for each facial image 302 is weighted according to the weight assigned at step 506, as described above in conjunction with FIG. 3. In some embodiments, training module 312 can minimize the objective function according to equation (2) such that sample weight pᵢ^{τ} is normalized using Zₚᵢ to equalize the total contribution of each output class.

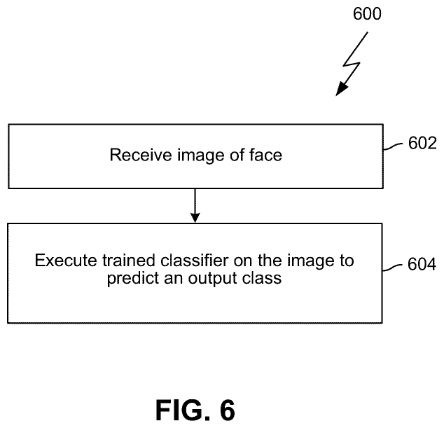

FIG. 6 is a flow diagram of method steps for executing application 146, according to various embodiments. Although the method steps are described in conjunction with the systems of FIGS. 1-4, persons skilled in the art will understand that any system configured to perform the method steps in any order falls within the scope of the various embodiments.

As shown, a method 600 begins at step 602, where application 146 receives an input image (e.g., image 402) that includes a face. In some embodiments, application 146 receives input images 402 from a storage system (e.g., data store 120).

At step 604, application 146 executes trained classifier 148 on the input image to predict an output class (e.g., output class 404). In some embodiments, classifier 148 is a trained machine learning model, such as an artificial neural network or a SVM, that is trained to perform a classification task according to method 500, described above in conjunction with FIG. 5. The output class is a specific category or label that trained classifier 148 predicts for the input image. The output class can be an output to any classification task for which trained classifier 148 was trained, such as a multi-label classification task with different classes of facial emotions (e.g., happy, sad, angry, and disgusted). In some embodiments, the output class can be an output to a binary classification task, such as classifying if a mouth is slightly open, or if the mouth is closed. In some embodiments, an output of application 146 can be the output class generated by classifier 148. In some other embodiments, the output class generated by classifier 148 can be used by application 146 to generate another output. In such embodiments, application 146 can generate the other output in any technically feasible manner.

In sum, techniques are disclosed for improving the identity-robustness of machine learning models. In some embodiments, a model trainer application first processes images of faces using a trained face recognition model to generate a proxy representation of an identity of the individual in each image. Representations of individuals with similar facial features lie in the same neighborhoods within a proxy identity space. A neighborhood can be defined with a hard threshold or a soft threshold. A hard threshold sets a radius of the neighborhood. A soft threshold is defined based on a distance metric, such as cosine distance. Instead of excluding representations of individuals outside a predefined distance, in some embodiments, a soft threshold can emphasize representations of individuals with closer distances and de-emphasize representations of individuals with further distances. The model trainer application trains a machine learning model to perform a task relating to faces while considering the accuracy of each identity proxy neighborhood. Instead of training the machine learning model to perform well on average, the model trainer assigns different weights to each image sample in a neighborhood based on the number of samples with the same output class in that neighborhood. The assigned weights can then be used to compute an unbiased identity loss function that is used to train the machine learning model to perform the task relating to faces while being robust to identity features.

At least one technical advantage of the disclosed techniques relative to the prior art is that, with the disclosed techniques, machine learning models can be trained to perform tasks relating to faces without relying on facial identity features, thereby improving robustness of the machine learning models. In addition, the disclosed techniques do not require balanced data points to train robust machine learning models for different output classes. These technical advantages represent one or more technological improvements over prior art approaches.

1. In some embodiments, a computer-implemented method for training a machine learning model comprises for each image included a plurality of images, generating a representation of a face within the image, for each image included the plurality of images, computing a weight based on the representation generated for the image and at least one other representation generated for at least one other image included in the plurality of images, and performing one or more operations to train the machine learning model based on at least the weights to generate a trained machine learning model.

2. The computer-implemented method of clause 1, wherein computing the weight comprises computing an intermediate weight based on at least one computed similarity between the representation generated for the image and the at least one other representation generated for the at least one other image, and computing the weight based on the intermediate weight and a number of classes being predicted by the machine learning model.

3. The computer-implemented method of clauses 1 or 2, wherein computing the intermediate weight comprises computing an exponential of the at least one computed similarity.

4. The computer-implemented method of any of clauses 1-3, further comprising computing each computed similarity included in the at least one computed similarity based on a cosine distance metric.

5. The computer-implemented method of any of clauses 1-4, wherein the weight computed for each image in the plurality of images is a conditional inverse density normalized based on a number of classes being predicted by the machine learning model.

6. The computer-implemented method of any of clauses 1-6, wherein performing the one or more operations to train the machine learning model comprises for each image included the plurality of images, computing a weighted loss based on a loss that is computed for the image and the weight that is computed for the image, and updating one or more parameters of the machine learning model based on the weighted losses.

7. The computer-implemented method of any of clauses 1-6, wherein generating the representation of the face within the image comprises processing the image via a trained facial recognition model.

8. The computer-implemented method of any of clauses 1-7, further comprising processing another image via the trained machine learning model.

9. The computer-implemented method of any of clauses 1-8, wherein the machine learning model comprises a classification model.

10. The computer-implemented method of any of clauses 1-9, wherein the machine learning model comprises a convolutional neural network.

11. In some embodiments, one or more non-transitory computer-readable media store instructions that, when executed by at least one processor, cause the at least one processor to perform steps comprising for each image included a plurality of images, generating a representation of a face within the image, for each image included the plurality of images, computing a weight based on the representation generated for the image and at least one other representation generated for at least one other image included in the plurality of images, and performing one or more operations to train a machine learning model based on at least the weights to generate a trained machine learning model.

12. The one or more non-transitory computer-readable media of clause 11, wherein computing the weight comprises computing an intermediate weight based on at least one computed similarity between the representation generated for the image and the at least one other representation generated for the at least one other image, and computing the weight based on the intermediate weight and a number of classes being predicted by the machine learning model.

13. The one or more non-transitory computer-readable media of clauses 11 or 12, wherein computing the intermediate weight comprises computing an exponential of the at least one computed similarity.

14. The one or more non-transitory computer-readable media of any of clauses 11-13, further comprising computing each computed similarity included in the at least one computed similarity based on a cosine distance metric.

15. The one or more non-transitory computer-readable media of any of clauses 11-14, wherein the weight computed for each image in the plurality of images is a conditional inverse density normalized based on a number of classes being predicted by the machine learning model.

16. The one or more non-transitory computer-readable media of any of clauses 11-15, wherein performing the one or more operations to train the machine learning model comprises for each image included the plurality of images, computing a weighted loss based on a loss that is computed for the image and the weight that is computed for the image, and updating one or more parameters of the machine learning model based on the weighted losses.

17. The one or more non-transitory computer-readable media of any of clauses 11-16, wherein generating the representation of the face within the image comprises processing the image via a trained facial recognition model.

18. The one or more non-transitory computer-readable media of any of clauses 11-17, further comprising processing another image that includes another face via the trained machine learning model.

19. The one or more non-transitory computer-readable media of any of clauses 11-18, wherein the weight is further computed based on a predefined distance for a neighborhood of representations of images.

20. In some embodiments, a system comprises a memory storing instructions, and a processor that is coupled to the memory and, when executing the instructions, is configured to perform the steps of for each image included a plurality of images, generate a representation of a face within the image, for each image included the plurality of images, compute a weight based on the representation generated for the image and at least one other representation generated for at least one other image included in the plurality of images, and perform one or more operations to train a machine learning model based on at least the weights to generate a trained machine learning model.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general-purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for training a machine learning model, the method comprising:
for each image included a plurality of images, generating a representation of a face within the image;
for each image included the plurality of images, computing a weight based on the representation generated for the image and at least one other representation generated for at least one other image included in the plurality of images; and
performing one or more operations to train the machine learning model based on at least the weights to generate a trained machine learning model.

2. The computer-implemented method of claim 1, wherein computing the weight comprises:
computing an intermediate weight based on at least one computed similarity between the representation generated for the image and the at least one other representation generated for the at least one other image; and
computing the weight based on the intermediate weight and a number of classes being predicted by the machine learning model.

3. The computer-implemented method of claim 2, wherein computing the intermediate weight comprises computing an exponential of the at least one computed similarity.

4. The computer-implemented method of claim 2, further comprising computing each computed similarity included in the at least one computed similarity based on a cosine distance metric.

5. The computer-implemented method of claim 1, wherein the weight computed for each image in the plurality of images is a conditional inverse density normalized based on a number of classes being predicted by the machine learning model.

6. The computer-implemented method of claim 1, wherein performing the one or more operations to train the machine learning model comprises:
for each image included the plurality of images, computing a weighted loss based on a loss that is computed for the image and the weight that is computed for the image; and
updating one or more parameters of the machine learning model based on the weighted losses.

7. The computer-implemented method of claim 1, wherein generating the representation of the face within the image comprises processing the image via a trained facial recognition model.

8. The computer-implemented method of claim 1, further comprising processing another image via the trained machine learning model.

9. The computer-implemented method of claim 1, wherein the machine learning model comprises a classification model.

10. The computer-implemented method of claim 1, wherein the machine learning model comprises a convolutional neural network.

11. One or more non-transitory computer-readable media storing instructions that, when executed by at least one processor, cause the at least one processor to perform steps comprising:
for each image included a plurality of images, generating a representation of a face within the image;
for each image included the plurality of images, computing a weight based on the representation generated for the image and at least one other representation generated for at least one other image included in the plurality of images; and
performing one or more operations to train a machine learning model based on at least the weights to generate a trained machine learning model.

12. The one or more non-transitory computer-readable media of claim 11, wherein computing the weight comprises:
computing an intermediate weight based on at least one computed similarity between the representation generated for the image and the at least one other representation generated for the at least one other image; and
computing the weight based on the intermediate weight and a number of classes being predicted by the machine learning model.

13. The one or more non-transitory computer-readable media of claim 12, wherein computing the intermediate weight comprises computing an exponential of the at least one computed similarity.

14. The one or more non-transitory computer-readable media of claim 12, further comprising computing each computed similarity included in the at least one computed similarity based on a cosine distance metric.

15. The one or more non-transitory computer-readable media of claim 11, wherein the weight computed for each image in the plurality of images is a conditional inverse density normalized based on a number of classes being predicted by the machine learning model.

16. The one or more non-transitory computer-readable media of claim 11, wherein performing the one or more operations to train the machine learning model comprises:
for each image included the plurality of images, computing a weighted loss based on a loss that is computed for the image and the weight that is computed for the image; and
updating one or more parameters of the machine learning model based on the weighted losses.

17. The one or more non-transitory computer-readable media of claim 11, wherein generating the representation of the face within the image comprises processing the image via a trained facial recognition model.

18. The one or more non-transitory computer-readable media of claim 11, further comprising processing another image that includes another face via the trained machine learning model.

19. The one or more non-transitory computer-readable media of claim 11, wherein the weight is further computed based on a predefined distance for a neighborhood of representations of images.

20. A system, comprising:
a memory storing instructions; and
a processor that is coupled to the memory and, when executing the instructions, is configured to perform the steps of:
for each image included a plurality of images, generate a representation of a face within the image,
for each image included the plurality of images, compute a weight based on the representation generated for the image and at least one other representation generated for at least one other image included in the plurality of images, and
perform one or more operations to train a machine learning model based on at least the weights to generate a trained machine learning model.
